(19) United States
(12) Patent Application Publication
(10) Pub. No.: US 2019/0018995 A1
(43) Pub. Date: Jan. 17, 2019

(54) SYSTEM AND METHOD FOR DECODING DYNAMIC BARCODE QUANTITIES

(71) Applicant: SYMBOL TECHNOLOGIES, LLC, Lincolnshire, IL (US)

(72) Inventors: David S. Koch, East Islip, NY (US); Lindsay M. Fahmi, Shelton, CT (US); Dongqing Chen, East Setauket, NY (US)

(21) Appl. No.: 15/843,477

(22) Filed: Dec. 15, 2017

Related U.S. Application Data
(60) Provisional application No. 62/531,513, filed on Jul. 12, 2017.

(51) Int. Cl. G06K 7/14; G06Q 10/08

(52) U.S. Cl. CPC G06K 7/1413; G06Q 10/087; G06K 7/1447

(57) ABSTRACT

A method in a data capture device of dynamically capturing indicia includes: responsive to initiation of a capture session, receiving a quantity indicator defining an expected number of the indicia to be captured during the capture session; capturing an indicium from a set of indicia and storing a string decoded from the indicium in a capture session buffer; responsive to storing the string, determining whether a number of strings in the capture session buffer matches the expected number defined by the quantity indicator; when the number of strings in the capture session buffer does not match the expected number, repeating (i) the capturing and the storing for a further indicium from the set of indicia, and (ii) the determining; and when the number of strings in the capture session buffer matches the expected number, generating a session termination signal to terminate the capture session.

### CROSS REFERENCE TO RELATED APPLICATION

This application claims priority from U.S. Provisional Application No. 62/531,513, filed Jul. 12, 2017, the entire contents of which are incorporated herein by reference.

### BACKGROUND

Indicia such as barcodes are employed to identify and track items in a wide variety of use cases. In certain use cases, it may be necessary to scan distinct barcodes for each of a plurality of items, such as units packed in a crate, pallet, or the like. The barcodes may be printed on a shipping manifest or the like. The scanning of such sets of barcodes is typically accomplished by manually initiating a separate scan session for each barcode, and is therefore time-consuming and error-prone.

Certain formats of labels, manifests or the like (e.g., electronic product labels with serialized goods or any labels such as those formatted according to the Automotive Industry Action Group (AIAG) standards) include barcodes encoding a quantity of items in the crate, pallet or the like. Although the quantity barcode may provide guidance permitting the operator of a barcode scanner to verify that the correct number of items are present, each of the item-specific barcodes is typically still scanned in a separate scan session.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a data capture device.

FIG. 2A is a block diagram of certain internal hardware components of the data capture device of FIG. 1.

FIG. 2B is a block diagram of certain internal components of the data capture device of FIG. 1.

FIG. 3 is a flowchart of a method of dynamically capturing indicia.

FIG. 4 is a flowchart of a method of receiving a quantity indicator for use in the method of FIG. 3.

FIGS. 5, 6 and 7A depict example scanning paths taken by the data capture device of FIG. 1 during the performance of the method of FIG. 3.

FIG. 7B depicts a display of the data capture device of FIG. 1 during the performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a data capture device of dynamically capturing indicia, comprising: responsive to initiation of a capture session, receiving a quantity indicator defining an expected number of the indicia to be captured during the capture session; capturing an indicium from a set of indicia and storing a string decoded from the indicium in a capture session buffer; responsive to storing the string, determining whether a number of strings in the capture session buffer matches the expected number defined by the quantity indicator; when the number of strings in the capture session buffer does not match the expected number, repeating (i) the capturing and the storing for a further indicium from the set of indicia, and (ii) the determining; and when the number of strings in the capture session buffer matches the expected number, generating a session termination signal to terminate the capture session.

Further examples disclosed herein are directed to a data capture device for dynamically capturing indicia, comprising: a data capture module; a memory containing a capture session buffer; and a processor interconnected with the data capture module and the memory, the processor configured to: responsive to initiation of a capture session, receive a quantity indicator defining an expected number of the indicia to be captured during the capture session; control the capture module to capture an indicium from a set of indicia, and store a string decoded from the indicium in the capture session buffer; responsive to storing the string, determine whether a number of strings in the capture session buffer matches the expected number defined by the quantity indicator; when the number of strings in the capture session buffer does not match the expected number, repeat (i) the capturing and the storing for a further indicium from the set of indicia, and (ii) the determining; and when the number of strings in the capture session buffer matches the expected number, generate a session termination signal to terminate the capture session.

Additional examples disclosed herein are directed to a non-transitory computer-readable medium storing a plurality of computer-readable instructions executable by a processor of a data capture device to perform a method of dynamically capturing indicia, the method comprising: responsive to initiation of a capture session, receiving a quantity indicator defining an expected number of the indicia to be captured during the capture session; capturing an indicium from a set of indicia and storing a string decoded from the indicium in a capture session buffer; responsive to storing the string, determining whether a number of strings in the capture session buffer matches the expected number defined by the quantity indicator; when the number of strings in the capture session buffer does not match the expected number, repeating: (i) capturing the indicium and storing the string for a further indicium from the set of indicia, and (ii) determining whether the number of strings matches the expected number; and when the number of strings in the capture session buffer matches the expected number, generating a session termination signal to terminate the capture session.

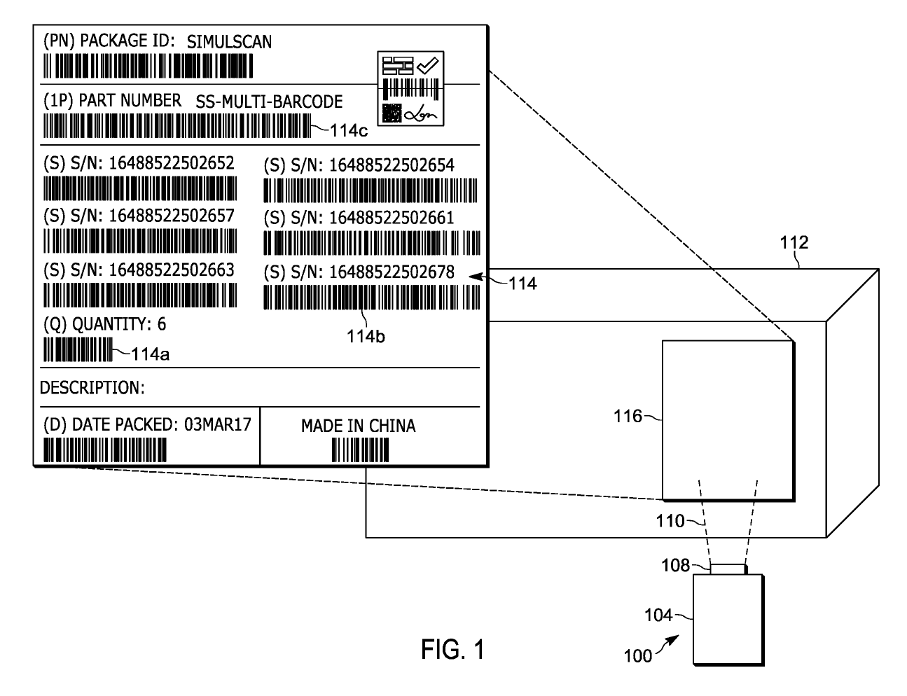

FIG. 1 depicts an example data capture device 100 in accordance with the teachings of this disclosure. The device 100 includes a housing 104 supporting the various other components discussed herein. In some examples, the housing 104 is a unitary structure supporting all other components of the device 100. In other examples, the housing 104 is implemented as two or more distinct (e.g. separable) housing components, such as a first component comprising a pistol-grip handle including a cradle configured to receive a second component comprising the housing of a smartphone, tablet computer, or the like.

The housing 104 supports a data capture module 108 configured to capture indicia within a field of view 110. The data capture module 108 includes any suitable combination of light emitters, reflectors and the like enabling the data capture module 108 to capture indicia. For example, the data capture module 108 in the present example is a laser-based barcode scanner. Also depicted in FIG. 1 is an object 112 such as a box, pallet or the like, bearing a plurality of indicia 114. In the present example, the indicia 114 are displayed on a sheet 116 affixed to the object 112; in other examples, however, the indicia 114 need not be displayed on a sheet, but can instead be displayed directly on the object 112, on a plurality of sheets or other objects, or the like.

The indicia 114, in the present example, include a plurality of one-dimensional barcodes (e.g. UPC-A, Code128 barcodes or the like). In other embodiments, some or all of the indicia 114 can be two-dimensional barcodes (e.g. QR Codes™). The indicia 114 also include at least two types of barcodes, distinguished by the data encoded within the indicia 114 (as will be discussed in greater detail below). In particular, the indicia 114 include at least a quantity indicium 114a and a plurality of serial number indicia 114b. In the example shown in FIG. 1, six indicia 114b are shown, for example each encoding a serial number for a corresponding part contained within the object 112. Other types of indicia may also be displayed on the object 112, such as a part number indicium 114c encoding a part number (e.g. the object 112 may contain six of a given part). A wide variety of other indicia 114 may also be included on the sheet 116, such as international mobile equipment identity (IMEI) numbers, electronic serial numbers (ESN), media access control (MAC) addresses, and the like. As noted above, the indicia 114 need not be presented on a single sheet, such as the sheet 116. For example, the indicia 114b may each be presented on distinct objects (such as boxes) on a shelving unit, while the quantity indicium 114a may be placed on the shelving unit itself (e.g. at one end of a row supporting the boxes bearing individual indicia 114b).

As will be discussed in greater detail below, the device 100 is configured to capture each of a plurality of indicia from the object 112, such as the serial number indicia 114b, in a single continuous scan session. To that end, the device 100 is configured to perform certain configurable validation actions on each indicium that is captured by the data capture module 108.

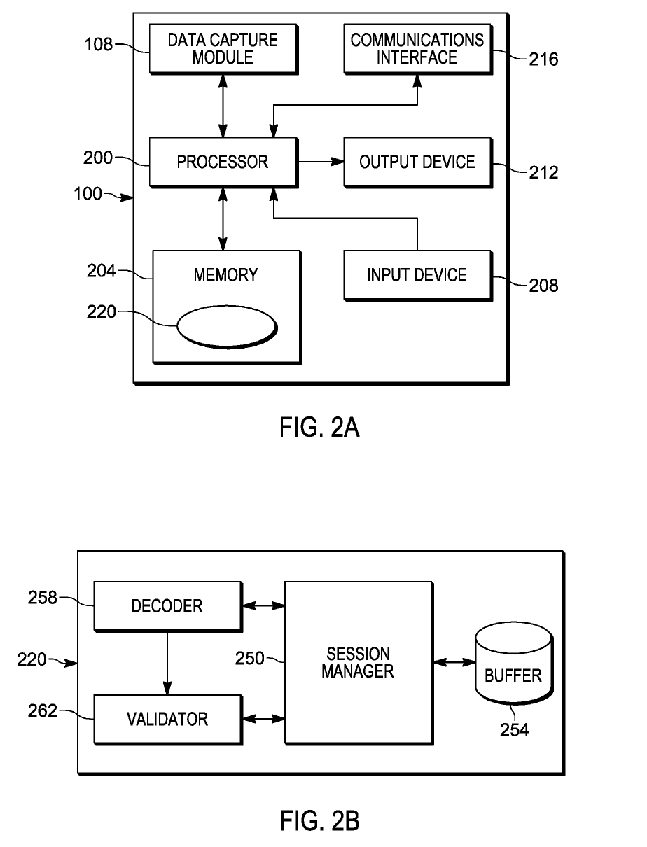

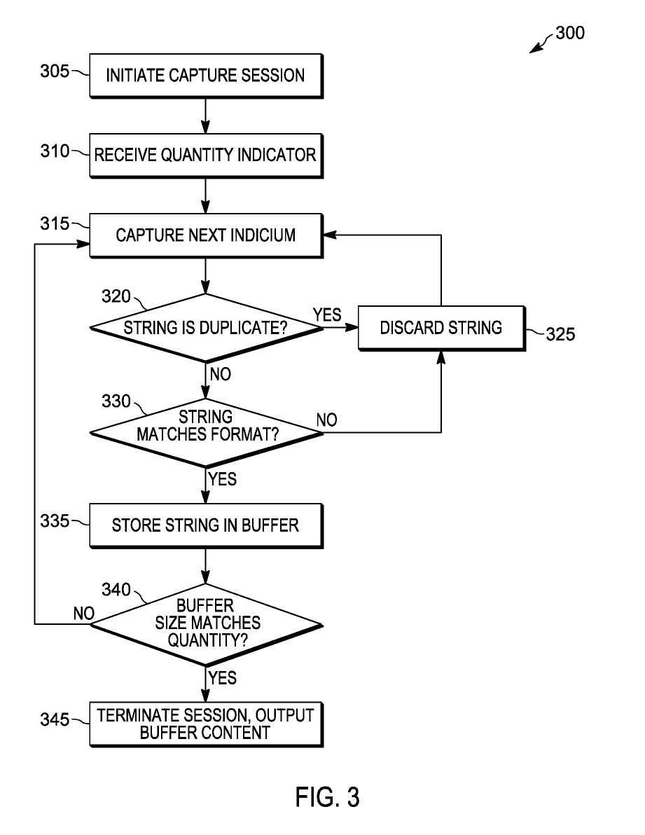

Turning to FIG. 2A, a schematic diagram of certain internal components of the device 100 is shown. The device 100 includes a central processing unit (CPU), also referred to as a processor 200, interconnected with a non-transitory computer readable storage medium, such as a memory 204. The memory 204 includes any suitable combination of volatile (e.g. Random Access Memory (“RAM”)) and non-volatile (e.g. read only memory (“ROM”), Electrically Erasable Programmable Read Only Memory (“EEPROM”), flash memory) memory. In general, the processor 200 and the memory 204 each comprise one or more integrated circuits.

The data capture device 100 also includes at least one input device 208 interconnected with the processor 200. As will be apparent to those skilled in the art, the input device 208 is configured to receive input and provide data representative of the received input to the processor 200. In the present example, the input device 208 includes a trigger supported by the housing 104, in response to the actuation of which the processor 200 controls the data capture module 108 to initiate a capture session for capturing the indicia 114. The input device 208 can also include a touch screen, a microphone, a keypad, and the like. The device 100 also includes at least one output device 212 interconnected with the processor 200. The output device 212, in the present example, includes a display supported by the housing 104. The display can be a flat-panel display, such as an organic light-emitted diode-based display (e.g. an active-matrix OLED, or AMOLED, display). In other examples, however, the display can be implemented with any of a wide variety of display technologies. In other examples (not shown), the output device 212 also includes any one of, or any suitable combination of, a speaker, a notification LED, and the like.

The device 100 also includes a communications interface 216 interconnected with the processor 200. The communications interface 216 includes any suitable hardware (e.g. transmitters, receivers, network interface controllers and the like) allowing the device 100 to communicate with other computing devices via a link with a network or with the other computing devices themselves. The specific components of the communications interface 216 are selected based on the type of network or other links that the device 100 is required to communicate over. For example, in the present example, the communications interface 216 includes a wireless transceiver based on the Bluetooth™ standard. In other examples, the communications interface 216 includes, in addition to or instead of the above-mentioned transceiver, transceivers or other control hardware for communicating over WiFi links, wired links (e.g. Ethernet), cell phone networks and the like.

The various components of the device 100 are interconnected, for example via one or more communication buses. The device 100 also includes a power source (not shown) for supplying the above-mentioned components with electrical power. In the present example, the power source includes a battery; in other examples, the power source includes a wired connection to a wall outlet or other external power source in addition to or instead of the battery.

The memory 204 stores a plurality of applications, each including a plurality of computer readable instructions executable by the processor 200. The execution of the above-mentioned instructions by the processor 200 causes the device 100 to implement certain functionality discussed herein. Each application is therefore said to be configured to perform that functionality in the discussion below.

In the present example, the memory 204 stores a capture control application 220, also referred to herein as the application 220. The device 100 is configured, via execution of the application 220 by the processor 200, to initiate and terminate capture sessions based on configurable parameters, for capturing a plurality of indicia during each session. In other examples, the processor 200, as configured by the execution of the application 220, is implemented as one or more specifically-configured hardware elements, such as field-programmable gate arrays (FPGAs) and/or application-specific integrated circuits (ASICs).

Turning to FIG. 2B, certain components of the application 220 are illustrated. In other embodiments, the components of the application 220 may be implemented as a plurality of distinct applications executed by the processor 200. In further examples, one or more of the components of the application 220 shown in FIG. 2B can be implemented as specifically configured hardware elements, rather than as computer-readable instructions for execution by the processor 200. For example, one or more of the components shown in FIG. 2B can be implemented as an FPGA, and ASIC, or the like.

The application 220 includes a session manager 250 configured to initiate and terminate capture sessions (e.g. to control the data capture module 108 to begin and end capturing indicia in the field of view 110) in response to various conditions to be discussed below. The session manager 250 is also configured to manage the content of a capture session buffer 254, which is configured to store data decoded from certain captured indicia, for further processing (e.g. by another application, not shown, in the memory 204) after the session has been terminated.

The application 220 also includes a decoder 258 configured to receive scanned input data from the data capture module 108 and to decode the scanned input data to derive or extract data, typically in the form of a string of characters, from the scanned input data. In some embodiments, the data capture module 108 itself is configured to perform such decoding; in those embodiments the decoder 258 can be omitted from the application 220.

The application 220 further includes a validator 262. The validator 262, as will be discussed below in greater detail, is configured to receive decoded strings from the decoder 258 and to evaluate one or more configurable criteria to determine whether to store each string in the buffer 254 (e.g., via the session manager 250). As will be apparent in the discussion below, the validator 262, the decoder 258, or both may have direct access to the buffer 254 in other embodiments.

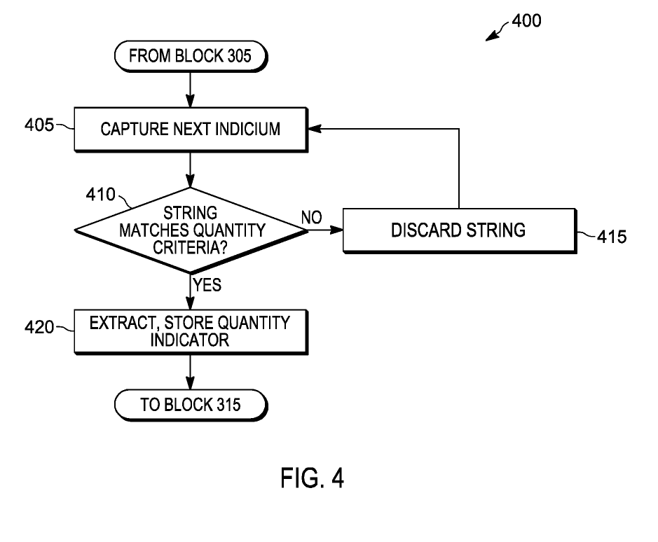

Turning to FIG. 3, a method 300 of dynamically capturing indicia is depicted. The method 300 will be described in conjunction with its performance by the device 100, with reference to the components of the device 100 as illustrated in FIGS. 2A and 2B.

At block 305, the session manager 250 is configured to initiate a capture session. Various mechanisms are contemplated for initiating capture sessions. For example, the session manager 250 can be configured to detect an actuation of the input device 208 (e.g. a trigger, selection of a soft button rendered on the display of the device 100 as detected via a touch screen). Responsive to receiving input data such as a trigger press, the session manager 250 is configured to initiate the data capture module 108 to begin capturing indicia within the field of view 110. For example, the data capture module 108 may be configured to begin emitting light (e.g. laser light) in the field of view 110 and providing scanned input data representing detected reflections of the emitted light to the decoder 258.

At block 310, the session manager 250 is configured to receive a quantity indicator. The quantity indicator indicates an expected number of indicia 114 of a configurable type to be captured during the capture session initiated at block 305. In the present example, the quantity indicator itself is extracted from an indicium 114. In particular, referring briefly to FIG. 1, the quantity indicator is extracted from the indicium 114a. However, the field of view 110 of the data capture module 108 may be directed at any of the indicia 114 upon initiation of the capture session at block 305. The application 220 therefore includes a template that defines one or more criteria for use (e.g. by the validator 262) in detecting a captured indicium that contains the quantity indicator. The template also defines one or more criteria for use in detecting captured indicia of the type to which the quantity indicator relates.

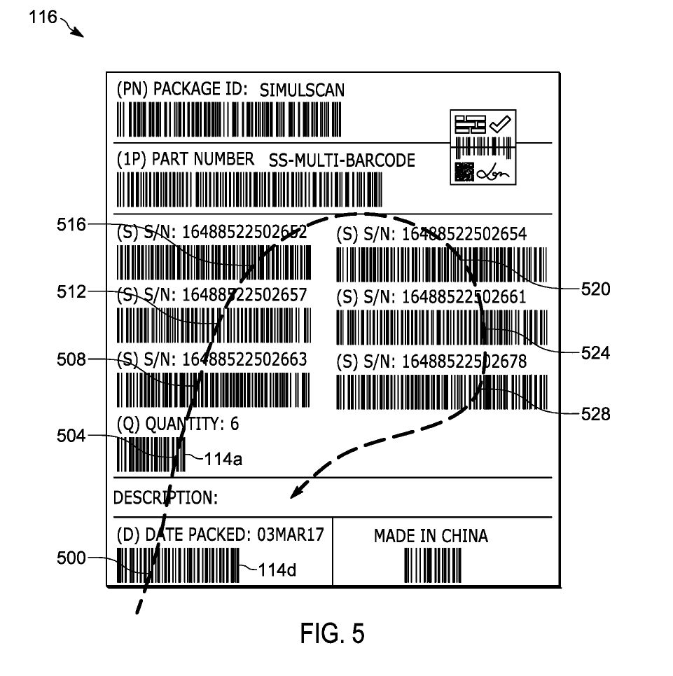

Turning to FIG. 4, a method 400 of receiving a quantity indicator (i.e. of performing block 305 of the method 300) is illustrated. At block 405, the device 100 is configured to capture an indicium (in this example, the first indicium captured in the session initiated at block 305). In particular, the decoder 258 is configured to receive and decode scanned input data from the data capture module 108. In the present example, the indicia 114 encode strings of various formats, and the output of the decoder 258 is therefore a string, which is passed to the validator 262.

At block 410, the validator 262 is configured to retrieve the above-mentioned template and determine whether the string received from the decoder 258 matches criteria defined in the template for a quantity-type indicium. An example template is shown below in Table 1.

TABLE 1
Example Template

| Indicium Type | Criteria | Output Identifier |
|---|---|---|
| Group Quantity | Begins with “Q” | QTY |
| Group Member(s) | Begins with “S” or “1S” | S/N # |

As seen above, the template defines criteria (which may also be referred to as format definitions) for two types of indicia. A “group quantity” indicium, according to the first criterion of the template, encodes a string beginning with the character “Q”. A “group member” indicium, according to the second criterion of the template, encodes a string beginning with the character “S” or beginning with the characters “1S”.

As will now be apparent, the group quantity criterion is employed by the validator 262 to determine whether the string received from the decoder 258 (derived from the “candidate” indicium captured at block 405) contains a quantity indicator. The group member criterion, meanwhile, defines the type of indicium of which a specific number (encoded in the quantity-type indicium) are expected to be received during the session initiated at block 305.

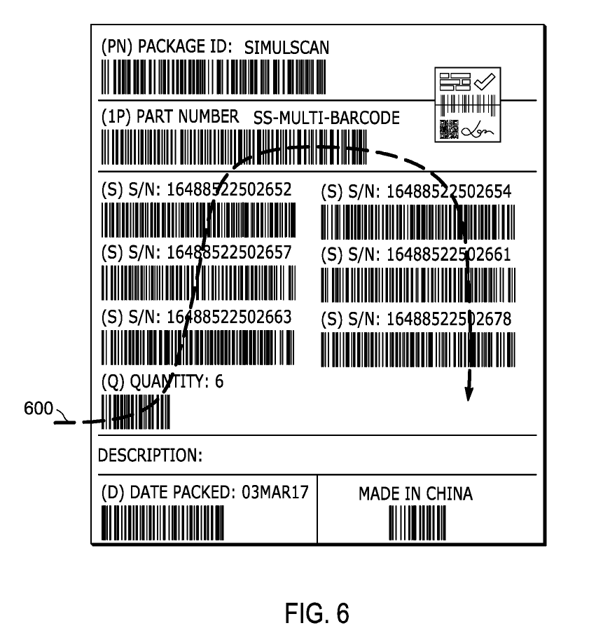

At block 410, therefore, the validator 262 is configured to determine whether the candidate string received from the decoder 258 begins with the character “Q” according to the template shown in Table 1. Referring to FIG. 5, a path traveled by the field of view 110 during the session initiated at block 305 is shown. In particular, a first location 500 along the path indicates that the indicium capture at block 405 is an indicium 114d, which encodes the string “D03MAR17”. Returning to FIG. 4, the determination at block 410 is therefore negative, because the string above does not begin with the character “Q”. The string is therefore discarded at block 415, and the next indicium is captured at block 405.

Referring again to FIG. 5, the next indicium is captured at the position 504. The indicium at the position 504 is the indicium 114a, which encodes the string “Q06”. The determination at block 410 is therefore affirmative, because the above-mentioned string begins with the character “Q”. At block 420, therefore, the validator 262 is configured to extract a quantity indicator from the string “Q06” and store the quantity indicator. For example, the validator 262 can be configured to pass the quantity indicator to the session manager 250 for later processing. The session manager 250 can also be configured to store the string “Q06” in the buffer 254. Extraction of the quantity indicator can be performed, for example, by stripping any non-numerical characters and any leading zeros from the string, resulting in a quantity indicator of “6”. The quantity indicator indicates, therefore, that six indicia of the “group member” type defined in the template are expected to be captured during the session initiated at block 305. Following the performance of block 420, the device 100 is configured to proceed with the performance of the method 300, at block 315.

At block 315, the device 100 is configured to capture a subsequent (i.e. after the indicium 114a) indicium. More specifically, the validator 262 is configured to receive a subsequent string decoded from a subsequent indicium captured by the decoder 258. Turning again to FIG. 5, the indicium captured in this performance of block 315 is at the position 508, which corresponds to one of the six indicia 114b on the sheet 116. In particular, the indicium at the position 508 encodes the string “S16488522502663”. At block 320, the validator 262 is configured to determine whether the above-mentioned string is a duplicate with any strings currently stored in the buffer 254. In some embodiments, the session manager 250 receives the string from the validator 262 and makes the determination at block 320. In the present example, the buffer 254 contains only the string “Q06”, and the determination at block 320 is therefore negative. When the determination at block 320 is affirmative, the indicium captured at block 315 is discarded at block 325, and the next indicium is captured at block 315.

Following a negative determination at block 320, the validator 262 is configured to determine, at block 330, whether the string matches a predefined criterion or format in the template of Table 1. In the present example, the determination at block 330 is affirmative, as the string “S16488522502663” begins with an “S” in accordance with the second criterion of Table 1. That is, the string received at the above instance of block 315 matches the “group member” indicium type.

When the determination at block 330 is negative, the device 100 proceeds to block 325 and discards the indicium as discussed above. Responsive to an affirmative determination at block 330, however, as in the present example, the validator 262 is configured to pass the string to the session manager 250 at block 335 for storage in the buffer 254.

At block 340, the session manager 250 is configured to determine whether the number of strings stored in the buffer 254 matches the quantity indicator received at block 310. More specifically, the session manager 250 is configured to determine whether the number of strings in the buffer 254 that match the “group member” type defined by the template is equal to the quantity indicator. In the present example, two strings are stored in the buffer 254 (“Q06” and “S16488522502663”), only one of which is of the “group member” type. The determination at block 340 is therefore negative, and the application 220 is configured to repeat the performance of blocks 315 to 335. Referring once again to FIG. 5, five additional performances of blocks 315 to 335 results in the capture and storage in the buffer 254 of strings decoded from the remaining five indicia 114b.

At the next performance of block 340, therefore, the determination is affirmative, because the buffer 254 contains a number of strings with the group member format defined by the template that is equal to the expected number defined by the quantity indicator received at block 310. The session manager 250 therefore proceeds to block 345, and terminates the capture session initiated at block 305. That is, the session manager 250 controls the data capture module 108 to cease emitting and capturing light to scan further indicia. The session manager 250 is also configured at block 345 to output the contents of the buffer 254, for example to another application in the memory 204. The template, as seen above in Table 1, can define an output format for use at block 345, for example by designating an output identifier or label to be provided with each string to the above-mentioned application. Thus, in the present example, the output generated by the session manager at block 345 is as shown below in Table 2.

TABLE 2
Session Manager Output

| Label | String |
|---|---|
| QTY | Q06 |
| S/N # | S16488522502663 |
| S/N # | S16488522502657 |
| S/N # | S16488522502652 |
| S/N # | S16488522502654 |
| S/N # | S16488522502661 |
| S/N # | S16488522502678 |

The device 100 can also be configured, for example via execution of the above-mentioned other application, to present the contents of Table 2 on the output device 212 (e.g. a display). Following the performance of block 345, the session manager 250 is configured to clear the buffer 254 for the next session.

In other example implementations, additional criteria may be specified in the template. Table 3 illustrates an example template defining a quantity indicator format definition and a group member format definition as in Table 1. The template below also, however, includes an additional format definition for a “part number” string. The part number definition indicates that in addition to an expected number of group member strings (as specified by the group quantity string), the sheet 116 is expected to include a part number string beginning with the characters “P” or “1P”.

TABLE 3
Example Template

| Indicium Type | Criteria | Output Identifier |
|---|---|---|
| Part Number | Begins with “P” or “1P” | P/N # |
| Group Quantity | Begins with “Q” | — |
| Group Member(s) | Begins with “S” or “1S” | S/N # |

As will now be apparent, a variety of additional string formats may be specified by the template. Further, additional group quantity and group member formats can be specified, for example if a first plurality of indicia of one type, and a second plurality of indicia of a second type (each with a corresponding quantity indicium) are expected to be present. As also seen above, the template of Table 3 does not include an output identifier for the quantity indicator string. Therefore, at block 345 when the session manager 250 outputs the contents of the buffer 254 following capture of the quantity indicium 114a, the six serial number indicia 114b and the product number indicium 114c via the path 600 shown in FIG. 6, the output is as shown below in Table 4.

TABLE 4
Session Manager Output

| Label | String |
|---|---|
| P/N # | 1PSS-MULTI-BARCODE |
| S/N # | S16488522502663 |
| S/N # | S16488522502657 |
| S/N # | S16488522502652 |
| S/N # | S16488522502654 |
| S/N # | S16488522502661 |
| S/N # | S16488522502678 |

As seen above, although the quantity indicium 114a was captured and the quantity indicator “6” was extracted therefrom to terminate the session at blocks 340 and 345, the string from which the quantity indicator was extracted is not output.

In other embodiments, the template can specify additional formatting criteria, such as character counts for the strings. As a further example, the template can specify that a type of indicium (such as the group quantity in Table 1) encodes a numerical string following the character “Q”. Thus, when an indicium is decoded that begins with the character “Q” but does not contain a number after the “Q”, the validator 262 is configured to discard the code at block 415. In further embodiments, the template can also specify output formatting for the strings in the buffer 254. For example, the template can specify an output format for the serial number indicia consisting of the right-most fourteen characters (i.e., without the leading “S”).

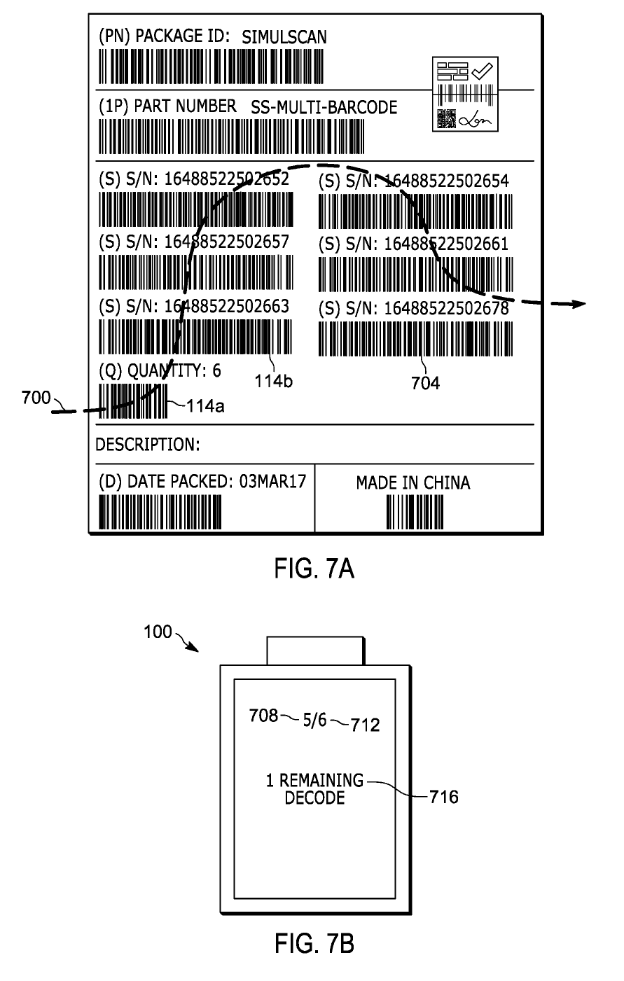

Various additional features and variations to the above systems and methods are contemplated. For example, referring to FIGS. 7A and 7B, the application 220 can be configured to control the output device 212 of the device 100 to present feedback during the capture session initiated at block 305. For example, the application 220 can be configured to present, e.g. on a display, a count of affirmative determinations at block 330 (i.e. the number of group member strings detected thus far) as well as the quantity indicator. In other words, the application 220 can control the display to present an indication of progress toward the quantity indicator.

As shown in FIG. 7A, for example, when the field of view 110 has travelled the length of the path 700, the quantity indicium 114a and five of the six serial number indicia 114b have been captured. However, the final serial number indicium 114b, at the position 704, has not yet been captured. Referring to FIG. 7B, the device 100 can be configured to present a progress indicator including the current number of group member indicia captured (708), the quantity indicator (712) and a difference 716 between the current number 708 and the quantity indicator 712. The application 220 may also be configured to generate an output signal responsive to each performance of block 335 (representing a successful detection and storage of a group member indicium). The output signal can include a sound (e.g. a beep), haptic feedback (e.g. a vibration of the device 100), an activation of an indicator LED, or the like.

The session manager 250 can also be configured to terminate the capture session initiated at block 305 before an affirmative determination is made at block 340. For example, the release of a trigger or the activation of a session interruption button, key or the like can cause the session manager 250 to end the session. In some embodiments, the session manager 250 is configured to automatically terminate the capture session when a configurable timeout interval has expired (e.g. twenty seconds). Referring to FIG. 7A, if the trigger is released at the end of the path 700 (or if the timeout interval expires), the application 220 can be configured to replace the display shown in FIG. 7B with an error message indicating that the capture session has been terminated. The buffer 254 may also be cleared (without generating any output at block 345). In some embodiments, the error message may be presented without terminating the session. In such embodiments, a timeout interval may be incremented to permit a further attempt to scan an indicium not previously scanned.

In further variations, the quantity indicator may be received from a source other than a quantity indicium as described above. For example, certain formats of sheet 116 may not include an indicium encoding a quantity. In such examples, the device 100 can be configured, at block 310, to receive the quantity indicator by generating a prompt (e.g. on the display) and receiving the quantity indicator as input data via the prompt.

In other embodiments, the receipt of a quantity indicator at block 310 is simply omitted. The determination at block 340 is therefore also omitted. Rather than determining whether an expected number of indicia have been captured, the device 100 can be configured to repeat the performance of blocks 315 to 335 until a command is received at the session manager 250 to terminate the session. The command can be the expiry of a timeout interval, the release of a trigger, or the like. In some examples, the device 100 can be configured to determine whether the number of strings stored in the buffer 254 matches a predetermined maximum number (e.g., 99).

The above-mentioned timeout interval may be dynamic in some embodiments. For example, the device 100 can be configured with an initial timeout interval, which is incremented during the session for each performance of block 335 (i.e. each successful decoding and storage of a string). For example, the interval may be incremented by one second for each performance of block 335.

In further examples, the indicia 114b need not relate directly to the contents of the object 112. For example, rather than serial numbers, product numbers or the like, the indicia 114b can encode information concerning the contents of the sheet 116 itself. For example, the sheet 116 can include a plurality of sub-regions. Each sub-region contains various information (which may be, but need not be, encoded in further indicia), and is associated with a particular indicium 114b. In this example, the indicia 114b can be referred to as anchor indicia. The location of each anchor indicium 114b may be employed by the device 100 to locate and extract the information from a corresponding one of the sub-regions. In such examples, the quantity indicium 114a can indicate an expected number of anchor indicia 114b present on the sheet 116.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a data capture device of dynamically capturing indicia, comprising:
responsive to initiation of a capture session, receiving a quantity indicator defining an expected number of the indicia to be captured during the capture session;
capturing an indicium from a set of indicia and storing a string decoded from the indicium in a capture session buffer;
responsive to storing the string, determining whether a number of strings in the capture session buffer matches the expected number defined by the quantity indicator;
when the number of strings in the capture session buffer does not match the expected number, repeating: (i) capturing the indicium and storing the string for a further indicium from the set of indicia, and (ii) determining whether the number of strings matches the expected number; and
when the number of strings in the capture session buffer matches the expected number, generating a session termination signal to terminate the capture session.

2. The method of claim 1, wherein generating the session termination signal includes controlling a capture module of the data capture device to automatically terminate the capture session.

3. The method of claim 1, wherein generating the session termination signal includes generating operator feedback via an output device of the data capture device.

4. The method of claim 1, wherein receiving the quantity indicator comprises:
generating a prompt for the quantity indicator on a display of the data capture device; and
receiving the quantity indicator via an input device of the data capture device.

5. The method of claim 1, wherein receiving the quantity indicator comprises:
capturing a quantity indicium from the set of indicia; and
storing the quantity indicator decoded from the quantity indicium.

6. The method of claim 5, wherein capturing the quantity indicium comprises:
retrieving a quantity indicator format definition;
capturing a candidate quantity indicium from the set of indicia; and
when a candidate string decoded from the candidate quantity indicium complies with the quantity indicator format definition, storing the candidate string as the quantity indicator.

7. The method of claim 1, further comprising:
retrieving a string format definition; and
responsive to capturing the indicium and prior to storing the string in the capture session buffer, verifying that the string complies with the string format definition.

8. The method of claim 1, further comprising:
presenting, on a display of the data capture device, a progress indicator including (i) the number of strings in the capture session buffer and (ii) the quantity indicator.

9. The method of claim 1, further comprising:
responsive to termination of the capture session prior to the number of strings in the capture session buffer matching the expected number, generating an error signal.

10. A data capture device for dynamically capturing indicia, comprising:
a data capture module;
a memory containing a capture session buffer; and
a processor interconnected with the data capture module and the memory, the processor configured to:
responsive to initiation of a capture session, receive a quantity indicator defining an expected number of the indicia to be captured during the capture session;
control the capture module to capture an indicium from a set of indicia, and store a string decoded from the indicium in the capture session buffer;
responsive to storing the string, determine whether a number of strings in the capture session buffer matches the expected number defined by the quantity indicator;
when the number of strings in the capture session buffer does not match the expected number, repeat: (i) capturing the indicium and storing the string for a further indicium from the set of indicia, and (ii) determining whether the number of strings matches the expected number; and
when the number of strings in the capture session buffer matches the expected number, generate a session termination signal to terminate the capture session.

11. The data capture device of claim 10, wherein the processor is further configured to generate the session termination signal by controlling the data capture module to automatically terminate the capture session.

12. The data capture device of claim 10, wherein the processor is further configured to generate the session termination signal by generating operator feedback via an output device of the data capture device.

13. The data capture device of claim 10, wherein the processor is further configured to receive the quantity indicator by:
generating a prompt for the quantity indicator on a display of the data capture device; and
receiving the quantity indicator via an input device of the data capture device.

14. The data capture device of claim 10, wherein the processor is further configured to receive the quantity indicator by:
capturing a quantity indicium from the set of indicia; and
storing the quantity indicator decoded from the quantity indicium in the memory.

15. The data capture device of claim 14, wherein the processor is configured to capture the quantity indicium by:
retrieving a quantity indicator format definition from the memory;
controlling the data capture module to capture a candidate quantity indicium from the set of indicia; and
when a candidate string decoded from the candidate quantity indicium complies with the quantity indicator format definition, storing the candidate string in the memory as the quantity indicator.

16. The data capture device of claim 10, wherein the processor is further configured to:
retrieve a string format definition from the memory; and
responsive to capturing the indicium and prior to storing the string in the capture session buffer, verify that the string complies with the string format definition.

17. The data capture device of claim 10, wherein the processor is further configured to control a display of the data capture device to present a progress indicator including (i) the number of strings in the capture session buffer and (ii) the quantity indicator.

18. The data capture device of claim 10, wherein the processor is further configured to: responsive to termination of the capture session prior to the number of strings in the capture session buffer matching the expected number, generate an error signal.

19. A non-transitory computer-readable medium storing a plurality of computer-readable instructions executable by a processor of a data capture device to perform a method of dynamically capturing indicia, the method comprising:
responsive to initiation of a capture session, receiving a quantity indicator defining an expected number of the indicia to be captured during the capture session;
capturing an indicium from a set of indicia and storing a string decoded from the indicium in a capture session buffer;
responsive to storing the string, determining whether a number of strings in the capture session buffer matches the expected number defined by the quantity indicator;
when the number of strings in the capture session buffer does not match the expected number, repeating: (i) capturing the indicium and storing the string for a further indicium from the set of indicia, and (ii) determining whether the number of strings matches the expected number; and
when the number of strings in the capture session buffer matches the expected number, generating a session termination signal to terminate the capture session.
